(19) United States
(12) Patent Application Publication
(10) Pub. No.: US 2013/0047174 A1
(43) Pub. Date: Feb. 21, 2013

(54) APPARATUS AND METHOD FOR MANIPULATING BROADCAST RECEIVING DEVICE

(71) Applicants: Hyo-Jin LEE, Seoul (KR); Jang-Wook OH, Seoul (KR); Jeong-Seok LEE, Seoul (KR)

(72) Inventors: Hyo-Jin LEE, Seoul (KR); Jang-Wook OH, Seoul (KR); Jeong-Seok LEE, Seoul (KR)

(73) Assignee: Pantech Co., Ltd., Seoul (KR)

(21) Appl. No.: 13/330,302

(22) Filed: Dec. 19, 2011

(30) Foreign Application Priority Data
Aug. 19, 2011 (KR) 10-2011-0083027

(51) Int. Cl. H04N 21/258; H04N 21/43; H04N 21/472

(52) U.S. Cl. 725/9; 725/38; 725/59

(57) ABSTRACT

An apparatus to manipulate a broadcast receiving device using a portable terminal obtains location information of a portable device and determines if any broadcast receiving devices and broadcast providing services are available at the location. The apparatus displays a user interface that allows a user to manipulate the broadcast receiving devices and broadcast providing services. Further, the apparatus detects a change in location of the portable terminal and may update the list of broadcast receiving devices and broadcast providing services that may be manipulated. A method for manipulating the broadcast receiving device includes obtaining the location of a portable terminal, collecting broadcast program information for broadcast receiving devices in the location, generating a user interface based on the broadcast program information and generating a signal to manipulate the device based on a user input into the user interface.

### CROSS-REFERENCE TO RELATED APPLICATION

This application claims priority from and the benefit of Korean Patent Application No. 10-2011-0083027, filed on Aug. 19, 2011, which is hereby incorporated by reference for all purposes as if fully set forth herein.

### BACKGROUND

1. Field

The following description relates to an application for a portable terminal, and more particularly, to a portable terminal application apparatus and method for manipulating a broadcast receiving device, and a portable terminal including the portable terminal application apparatus.

2. Discussion of the Background

Various television broadcast services have been offered with the development of information communication technologies. Television broadcast services may be classified into public network broadcast services, satellite broadcast services, terrestrial digital multimedia broadcast (DMB) services, local cable broadcast services, and internet protocol television (IPTV) services. The television broadcast services may be provided not only via television receivers but also various portable devices, such as personal computers or tablet PCs, which may employ a set-top box or a television broadcast receiver, a portable multimedia player (PMP), a mobile communication terminal, a smart phone, a navigation device, and the like.

A fixed-type broadcast receiving device, such as a set-top box and a television receiver, is generally provided with a remote control to control the device. The remote control may allow a user to manipulate the broadcast receiving device remotely, for example, to change a channel without approaching to the device, or to adjust settings related to conditions for watching the broadcast program. However, the remote control is designed for use with a dedicated broadcast receiving device of a particular type and/or a manufacture, and thus generally it is difficult to use one remote control to manipulate multiple broadcast receiving devices of different manufacturers and/or various types of broadcast receiving devices.

To overcome the drawbacks of the conventional remote control, remote controls capable of manipulating different types of devices of the same manufacturer and broadcast receiving devices of different manufacturers have been developed and widely used. However, because a remote control is used for a particular broadcast receiving device which is usually placed at a fixed position, the remote control is not carried by user. When the user moves to a different location, it is usual for the user to use a remote control at that site to manipulate a broadcast receiving device at that location.

For a user to manipulate different broadcast receiving devices at different locations with a single device, a remote control needs to be implemented in a device that the user always carries. For example, if a remote control is added to a mobile phone, a smart phone, a PMP, or an MP3 player, the user may be able to control various types of broadcast receiving devices at different locations using his/her portable terminal. Accordingly, a mobile phone having a remote-control has been introduced.

Recently, applications for use in smart phones have been designed to implement a remote control. Such applications provide a screen on a display of the smart phone, as a graphic user interface (GUI), which contains images of the same shapes as the buttons of a remote control. While using the application, the user may be required to watch both the remote control GUI on the display of the smart phone and a menu image on a television to control the application.

Television broadcast services have moved into a variety of broadcast services including public network broadcasting, satellite broadcasting, terrestrial digital multimedia broadcasting (DMB), local cable broadcasting, and IPTV broadcasting, which are categorized based on the types of media used to transfer broadcast content or a transmission scheme. Additionally, various types of broadcast receiving devices to receive and reproduce the broadcast content have been offered due to an increase in the different types of broadcasting media. Moreover, a variety of broadcast receiving devices used for the same broadcasting medium have been developed by different manufacturers. These broadcast receiving devices may provide different user interfaces, and therefore a remote control for integrated control of multiple devices may have an increasing number of operable buttons, which may increase the complexity of the remote control and thus make it difficult for the user to operate the remote control. For example, with respect to the same broadcasting medium and the same broadcast receiving device, each broadcasting medium uses different channels in different locations and some broadcasting medium have different broadcast content depending on the location of a device, even when using an integrated remote control or a portable terminal having a relevant application with the integrated remote control, and it is still difficult for the user to view a desired program via a different broadcast receiving device at a different location.

The above information disclosed in this Background section is only for enhancement of understanding of the background of the invention and therefore it may contain information that does not form any part of the prior art.

### SUMMARY

Exemplary embodiments of the present invention provide an apparatus of a portable terminal to manipulate a broadcast receiving device, and in particular an apparatus to collect and display broadcast program information on a portable terminal for a user to control a broadcast receiving device.

Exemplary embodiments of the present invention also provide an apparatus and method for manipulating a broadcast receiving device that can automatically update broadcast program information displayed to a user based on a change in location of a portable terminal.

Additional features of the invention will be set forth in the description which follows, and in part will be apparent from the description, or may be learned by practice of the invention.

An exemplary embodiment of the present invention discloses an apparatus of a portable terminal to manipulate a first broadcast receiving device, comprising: an information collecting unit to collect broadcast program information for a broadcast service provider; a user interface and processing unit to generate a user interface based on the collected broadcast program information, and to receive a user input through the user interface; and a broadcast receiving device control unit to generate a signal to manipulate the first broadcast receiving device in response to the user input.

An exemplary embodiment of the present invention also discloses an apparatus of a portable terminal to manipulate a first receiving device and a second receiving device, including: a location information acquiring unit to acquire a first location of the portable terminal and the first receiving device; an information collecting unit to collect first broadcast program information for a first broadcast service provider based on the location of the first receiving device; a user interface and processing unit to generate a first user interface based on the first broadcast program information, and to receive a user input through the user interface; and a broadcast receiving device control unit to generate a signal to manipulate the first broadcast receiving device, wherein in response to a change of the portable terminal from the first location to a second location: the information collecting unit collects second broadcast program information for a second broadcast service provider based on the second location, the user interface and processing unit generates a second user interface based on the second broadcast program information, and the broadcast receiving device control unit generates a signal to manipulate the second broadcast receiving device in the second location.

An exemplary embodiment of the present invention also discloses a method for manipulating a broadcast receiving device, comprising: obtaining first location information of a portable device; obtaining a first broadcast program information of a first broadcast service provider according to the first location information; generating a first user interface according to the first broadcast program information; and in response to a request, generating a signal to control a first broadcast receiving device located in the first location.

An exemplary embodiment of the present invention also discloses a broadcast receiving device to be manipulated by a portable terminal, comprising: a communication unit to transmit broadcast program information of a broadcast service provider to the portable terminal and to receive a user input from the portable terminal; a manipulation unit to perform an operation in response to an input from the portable terminal, wherein the broadcast service provider is at least one of a local cable broadcasting service, a satellite broadcast service, a terrestrial digital multimedia broadcast (DMB) service, a local cable broadcast service, and an internet protocol television (IPTV) service.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a portable terminal application apparatus according to an exemplary embodiment of the present invention.

FIG. 2A is a diagram illustrating a database according to an exemplary embodiment of the present invention.

FIG. 2B is a diagram illustrating a user's favorite program database according to an exemplary embodiment of the present invention.

FIG. 2C is a diagram illustrating a genre database according to an exemplary embodiment of the present invention.

FIG. 2D is a diagram illustrating a user setting database according to an exemplary embodiment of the present invention.

FIG. 2E is a diagram illustrating a program icon database according to an exemplary embodiment of the present invention.

FIG. 2F is a diagram illustrating a reservation database according to an exemplary embodiment of the present invention.

FIG. 2G is a diagram illustrating a notification database according to an exemplary embodiment of the present invention.

FIG. 3 is a flowchart illustrating a method for collecting and storing broadcast program information according to an exemplary embodiment of the invention.

FIG. 4A is a diagram illustrating a user interface according to an exemplary embodiment of the invention.

FIG. 4B is a diagram illustrating a user interface according to an exemplary embodiment of the invention.

FIG. 4C is a diagram illustrating a user interface according to an exemplary embodiment of the invention.

FIG. 4D is a diagram illustrating a user interface according to an exemplary embodiment of the invention.

FIG. 4E is a diagram illustrating a user interface according to an exemplary embodiment of the invention.

FIG. 4F is a diagram illustrating a user interface according to an exemplary embodiment of the invention.

FIG. 4G is a diagram illustrating a user interface according to an exemplary embodiment of the invention.

FIG. 5 is a flowchart illustrating a method for controlling a broadcast receiving device according to an exemplary embodiment of the present invention.

FIG. 6 is a flowchart illustrating a method for manually setting the broadcast receiving device of FIG. 5 according to an exemplary embodiment of the present invention.

FIG. 7 is a flowchart illustrating a method for automatically programming a broadcast receiving device in FIG. 5 according to an exemplary embodiment of the present invention.

FIG. 8 is a flowchart illustrating a method for controlling a broadcast receiving device in FIG. 5 according to an exemplary embodiment of the present invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

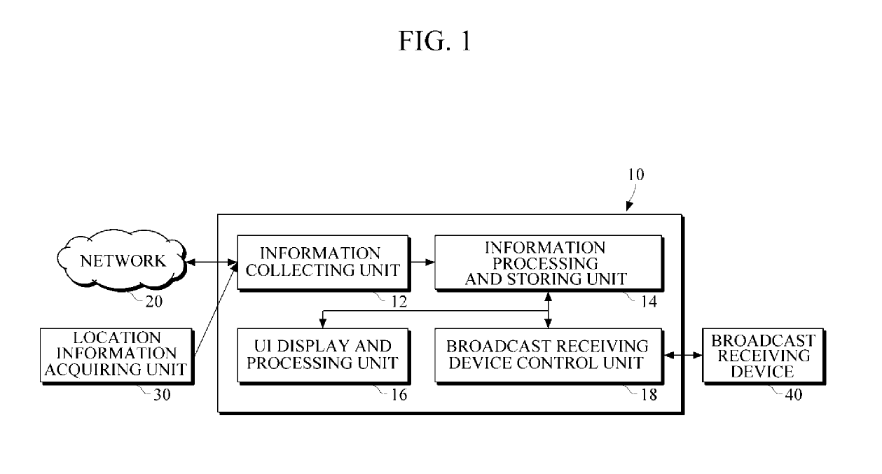

FIG. 1 is a block diagram illustrating a portable terminal application apparatus according to an exemplary embodiment of the present invention. The portable terminal application apparatus 10 (hereinafter, it will be referred to as an “application apparatus”) may be implemented as an electronic circuit and/or hardware that is installed inside a portable terminal or as a module of a processor or an application program which is provided to or installed in a portable terminal. In the latter case, the application apparatus 10 may be incorporated into a portable terminal or be installed in the portable terminal as an application program.

The portable terminal may be an apparatus that transmits and receives data wired or wirelessly over a network 20. The network 20 is not limited in type, and may be, for example, a wireless local access network (WLAN), a wired LAN, the Internet, a mobile communication network (for example, 3G, 4G, WiBro®, and the like), a wireless personal access network (WPAN), such as Bluetooth® and Zigbee®, and an infrared data communication network (for example, infrared data association (IrDA)). The portable terminal may include a remote control to control various broadcast receiving devices 40 using infrared or wireless resources. Moreover, the portable terminal may include a location information acquiring unit 30 having a global positioning system (GPS) receiver and/or using a communication network (for acquiring base-station-based location information) to obtain location information.

Referring to FIG. 1, the application apparatus 10 includes an information collecting unit 12, an information processing and storing unit 14, a user interface (UI) display and processing unit 16, and a broadcast receiving device control unit 18.

The information collecting unit 12 may collect broadcast program information. The broadcast program information may include channel information of various broadcast services including a public broadcast service, a satellite broadcast service, a local cable broadcast service, and an IPTV broadcast service, as well as at least channel schedules. The channel schedule information may include detail information for each program, for example, a genre of the program, main cast, program summary, icons associated with the program, and icons associated with the channel.

The information collecting unit 12 is not limited by the types of sources for the broadcast program information. For example, the information collecting unit 12 may collect the broadcast program information from a server (for example, a website of a broadcasting company) of a broadcast service provider, an individual service server which offers broadcast program information and/or the broadcast receiving device 40 which may stores electronic program guide (EPG) information to be provided along with the broadcast content.

The information collecting unit 12 may access a source that offers the broadcast program information via the network 20 to collect the broadcast program information. More specifically, the information collecting unit 12 may access a website of each broadcasting company or a server that offers broadcast program information through the network 20, may parse information provided by the server in a reference format (for example, information in HTML format displayed on a website or EPG information stored on the website), and may obtain the broadcast program information.

The information collecting unit 12 may collect broadcast program information for one or more specific locations. This is because channel information and/or program information of public broadcasting, local cable broadcasting, and territorial DMB may vary with location. Thus, if a given broadcast service broadcasts nationally the same program via the same channel, the information collecting unit 12 may not need to collect the program information of each location with respect to the broadcast service.

The specific location may be where the portable terminal having the application apparatus 10 is located, but it may not be limited thereto. The specific location may be an arbitrary location selected by a user. In former case, the information collecting unit 12 may receive location information from the location information acquiring unit 30 of the portable terminal to obtain the information about the location of the portable terminal. The location information acquiring unit 30 may be a device installed in the portable terminal to recognize the location of the portable terminal, or a unit to acquire the location information of the portable terminal through the network 20. For example, the location information collecting unit 30 may use a GPS receiver to acquire location information and/or may acquire location information based on locations of nearby base stations. In contrast, in the latter case, the user may manually specify a user's current position or select an arbitrary location (for example, a location to which the user is moving) at which the user intends to use the application apparatus 10 in the future.

The information collecting unit 12 may collect or update broadcast program information at a specific time (for example, at a time set by the user) and/or periodically. For example, the information collecting unit 12 may update the broadcast program information periodically or at a time it determines the update is required (for example, if an acquired channel or broadcast program information has been expired). To update the broadcast program information, the information collecting unit 12 may recollect information about the same broadcast service, channel, and program based on the stored broadcast program information. Alternatively, the information collecting unit 12 may collect or update the broadcast program information if the portable terminal has changed location, if the broadcast receiving device 40 to be controlled has been changed, and/or if there is a user request to collect broadcast program information.

The information collecting unit 12 may collect information to control the broadcast receiving device 40. The broadcast receiving device 40 may be, for example, a television receiver or a set-top box that is used for a particular broadcast service. The broadcast receiving device 40 may be a content reproducing device, such as an audio player and a multimedia player. The information collecting unit 12 may collect infrared frequency information to control the broadcast receiving device 40. If information to control the broadcast receiving device 40 is already stored (for example, if the information is natively stored in the portable terminal having the application apparatus 10 or has been already collected and stored in the portable terminal), the information collecting unit 12 may not need to collect the relevant information.

The information processing and storing unit 14 may store the whole or part of the information collected by the information collecting unit intact. Alternatively, the information processing and storing unit 14 may process all or a part of the collected information into a reference format, and store the processed information in a database (DB). If the broadcast program information collected by the information collecting unit 12 is related to previously collected information, for example, if the collected information relates to the broadcast program information of the broadcast receiving device 40 which is at the same location and has been previously registered in the application apparatus 10, the information processing and storing unit 14 may update the database with respect to the broadcast receiving device 40 by processing the broadcast program information transferred from the information collecting unit 12. On the other hand, if the broadcast program information collected by the information collecting unit 12 is new information, for example, if the application apparatus 10 is placed in a different location or if a new broadcast receiving device 40 is used that has not been registered in the application apparatus 10, the information processing storing unit 14 may process the broadcast program information transferred from the information collecting unit 12 and build a new database. The database may be a memory mounted on the application apparatus 10, a memory (internal or external memory) of the portable terminal having the application apparatus 10, or storage space on a network.

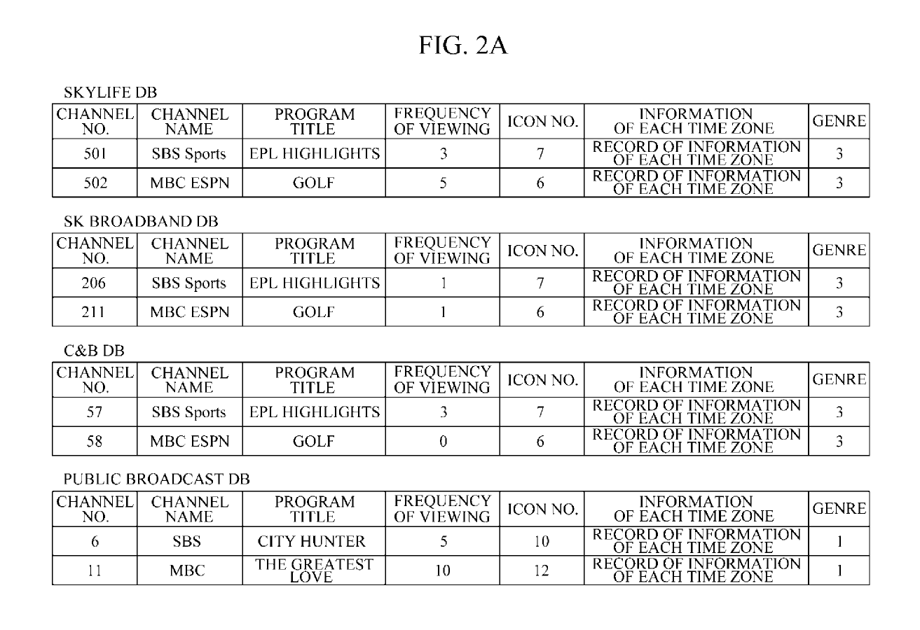

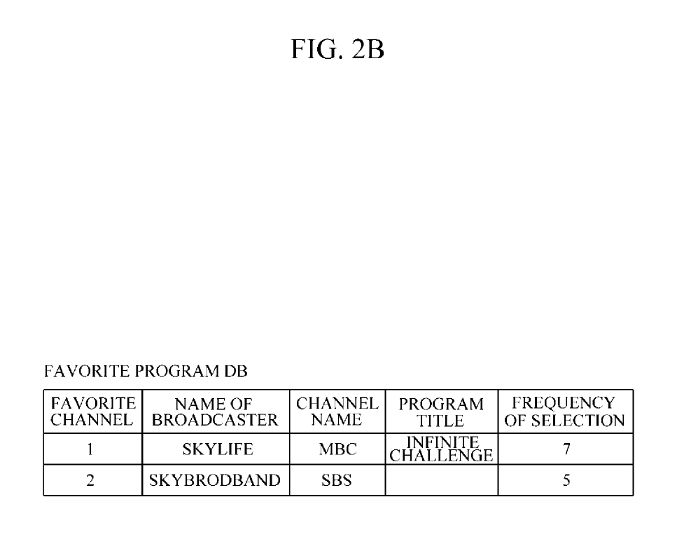

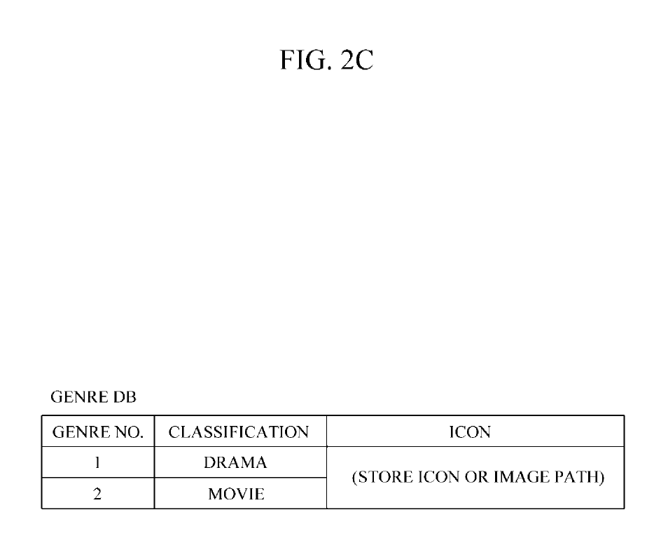

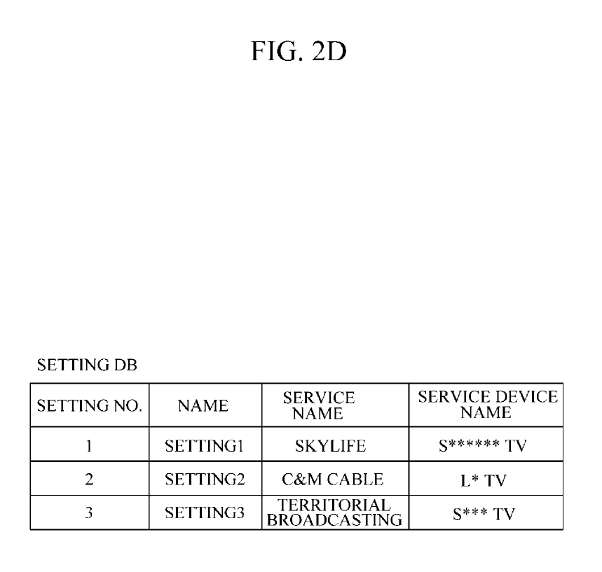

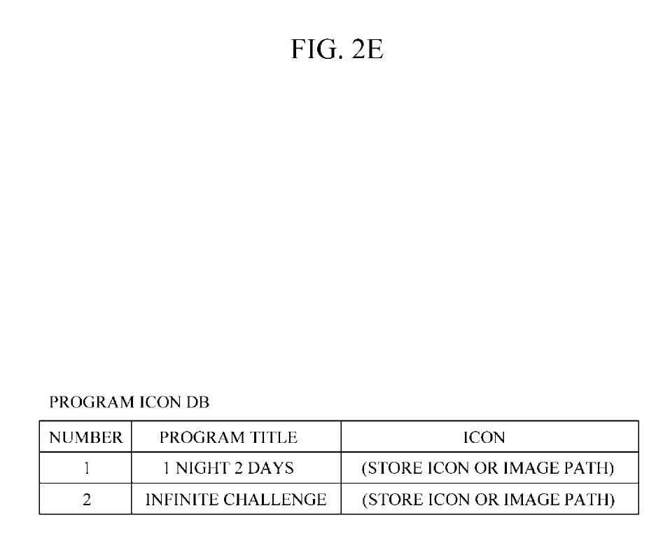

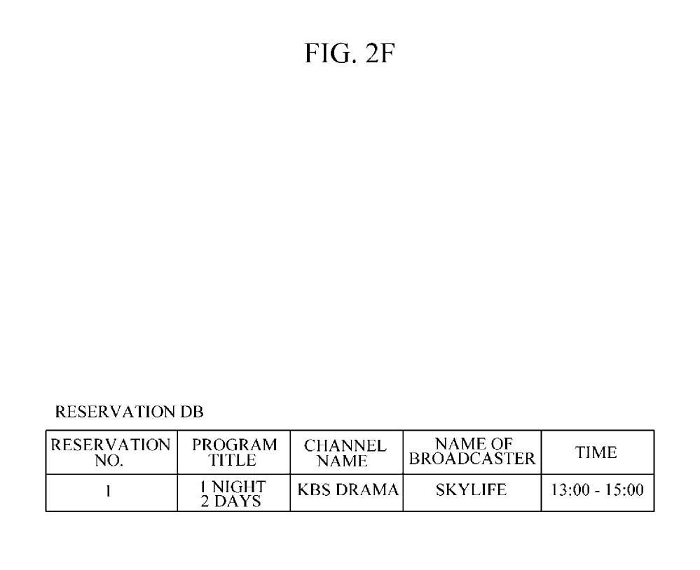

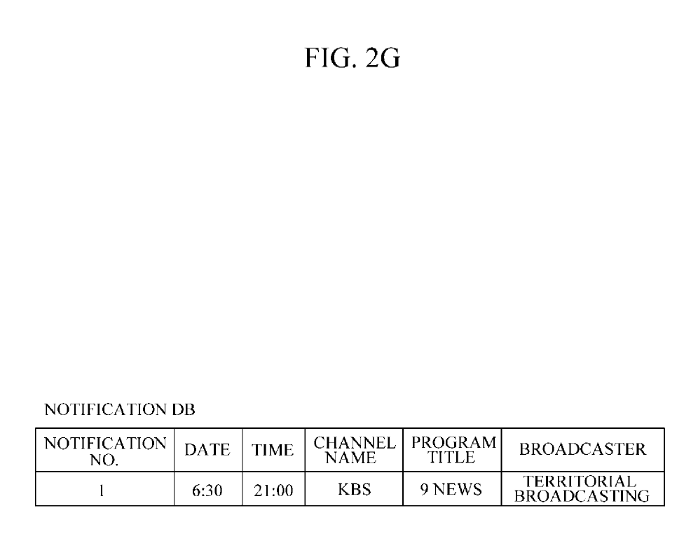

FIG. 2A is a diagram illustrating a database according to an exemplary embodiment of the present invention. If building a database with respect to the specific broadcast receiving device 40, the information processing and storing unit 14 may store broadcast program information in the database on the basis of broadcast service. For example, the information processing and storing unit 14 may build one of a satellite broadcast database, an IPTV database, a cable broadcast database, and a public broadcast database or multiple databases for each broadcast service. The database for each broadcast service may include information regarding a channel number, a channel name, a program title, and a broadcast time (where two or more episodes of a program are broadcast, all broadcast schedule information may be included). In addition, the database for each broadcast service may further include a genre of the program, cast, content information such as a rating of the program, the number of times the program has been viewed, an icon of the program, and the like. In FIG. 2A, formats for Skylife database (DB), a satellite broadcast service, SK Broadband® DB, an IPTV service, a C & B DB, a local cable broadcast service, and a public broadcast database are illustrated.

FIG. 2B is a diagram illustrating a user's favorite program database according to an exemplary embodiment of the present invention. The information processing and storing unit 14 may use the broadcast program information collected by the information collecting unit 12 or the aforementioned database for each broadcast service to establish a database of a +user's favorite programs. The user's favorite programs may be determined according to an arbitrary criterion. For example, more frequently watched programs may be determined as the favorite programs based on a TV view history, and/or the user may select the user's own favorite programs. Alternatively, these two methods may be combined to determine favorite programs.

FIG. 2C is a diagram illustrating an example of a genre database according to an exemplary embodiment of the present invention. The information processing and storing unit 14 may use the broadcast program information collected by the information collecting unit 12 or the aforementioned database of each broadcast service to build a database for each genre. The broadcast programs of all channels offered by one broadcast service may be categorized into a number of genres including ‘Drama,’ ‘Movie,’ ‘Sport,’ ‘Entertainment,’ ‘Documentary,’ ‘Music,’ and so on, and databases for each genre may be established.

FIG. 2D is a diagram illustrating a user setting database according to an exemplary embodiment of the present invention. The information processing and storing unit 14 may also use the broadcast program information collected by the information collecting unit 12 or the aforementioned database of each broadcast service to build a user setting database. The user setting database may be a database to facilitate user convenience in selecting a specific broadcast service and/or a specific broadcast channel from the broadcast receiving device 40. Alternatively, the user setting database may be a user's favorite program database or a user's favorite channel database, which is established based on the user's preference.

FIG. 2E is a diagram illustrating a program icon database according to an exemplary embodiment of the present invention. The information processing and storing unit 14 may further build and/or store different types of databases for the application apparatus 10. For example, the information processing and storing unit 14 may build a program icon database that stores icons of each broadcast programs and/or a channel icon database that stores icons of each channel. FIG. 2F is a diagram illustrating a reservation database according to an exemplary embodiment of the present invention. FIG. 2G is a diagram illustrating a notification database according to an exemplary embodiment of the present invention. The information processing storing unit 14 may build and store a reservation database that stores user's reservation information for a specific broadcast program, a notification database to notify the reservation information or other information (for example, notification information for a specific program) set by the user, and the like. The information processing and storing unit 14 may build and store a database of information regarding previously registered broadcast service providers, information regarding the broadcast receiving device 40 (for example, a list of broadcast receiving devices being set at a particular location and relevant control information), and information regarding reproducing devices.

Referring again to FIG. 1, the UI display and processing unit 16 may display a specific UI on the display of the portable terminal having the application apparatus 10. For example, the UI display and processing unit 16 may sequentially display an initial operation UI and a follow-up UI that results from manipulating the initial operation UI. The initial operation UI may be a UI to obtain, for example, control of the broadcast receiving device 40 and/or broadcast program information, but may not be limited thereto the UI display and processing unit 16 may display one or more channel icons to assist the user in selecting a desired channel and one or more user's favorite program icons to assist the user in selecting a desired broadcast program. Moreover, the UI display and processing unit 16 may display a broadcast program schedule of a channel that the user has viewed, other information requested by the user, an input menu to receive information or instructions, and the like.

The UI display and processing unit 16 may perform a specific process in response to a user's input in the display UI. For example, if the user selects a certain broadcast channel from the displayed UI, a selection signal for generating a control signal to change a current channel of the broadcast receiving device 40 to the selected channel, or a control signal display a program schedule of the relevant channel to perform a shortcut or reserve a program may be transmitted to the broadcast receiving device control unit 18. If the user selects a particular program from the display UI, the UI display and processing unit 16 may transmit a control signal to the broadcast receiving device control unit 18 to change the current channel of the broadcast receiving device 40 to a channel on which the selected program is currently being broadcast, or search for a channel on which the relevant program is currently being broadcast or is scheduled to be broadcast and display the found channel to perform a shortcut or reserve a program. Further, the UI display and processing unit 16 may allow for the adjustment of the settings of the application apparatus 10, settings for the operation of the application apparatus 10, and personal settings for the user, and allow executing and terminating the application apparatus 10.

The broadcast receiving device control unit 18 may generate and output a control signal to control the broadcast receiving device 40 in response to an input signal. The input signal received by the broadcast receiving device control unit 18 may be a reference selection signal that is generated by the UI display and processing unit 16 in response to a user's input on a button of the display. As described above, the information processing and storing unit 14 may store signals for control of each type of broadcast receiving devices 40, and the broadcast receiving device control unit 18 may generate a control signal with reference to the signals stored in the information processing and storing unit 14. The broadcast receiving device 40 may be a television receiver, a set-top box, an audio player, or a video player. The broadcast receiving device 40 should be designed to be remotely controllable. According to the embodiment, the broadcast receiving device 40 may be a device capable of data communication (for example, transmission of a program schedule) with the application apparatus 10.

The broadcast receiving device control unit 18 adjusts settings of the broadcast receiving device 40 to control the broadcast receiving device 40. There may be a manual setting adjustment method, an automatic setting adjustment method, and the like, and the settings of the broadcast receiving device 40 may be adjusted according to supported setting methods of the broadcast receiving device 40. Each setting method will be described in more detail later.

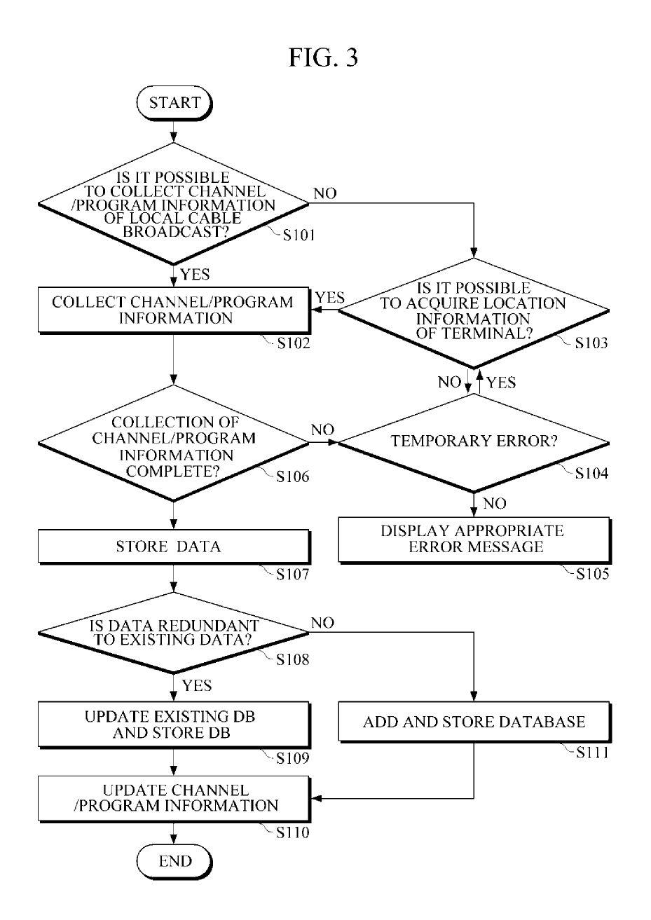

FIG. 3 is a flowchart illustrating a method for collecting and storing broadcast program information according to an exemplary embodiment of the invention. FIG. 3 is a flowchart illustrating a method of the information collecting unit 12 of the application apparatus 10 shown in FIG. 1 collecting broadcast program information and the information processing and storing unit 14 processing and storing the collected information according to an exemplary embodiment of the invention. Referring to FIG. 1 and FIG. 3, the method shown in FIG. 3 is performed under the assumption that the information collecting unit 12 collects channel information of a local cable broadcast and the program information of the channel and the information processing and storing unit 14 stores the collected information. The same or similar procedures can be carried out for different types of broadcast services. Hereinafter, operations of the application apparatus 10 will be described in more detail with reference to FIG. 1 and FIG. 3.

Referring again to FIG. 1 and FIG. 3, in operation S101, the information collecting unit 12 may determine whether it is possible to collect information regarding a local cable broadcast channel in a current location and broadcast program information (channel/program information) of the relevant channel. If it is determined that it is possible to collect the information regarding the local cable broadcast channel and the broadcast program information (for example, if location information of the relevant location is already known), the channel/program information is collected in operation S102. As described with respect to the information collecting unit 12 of FIG. 1, there is no limitation on the source for collecting the channel/program information in operation S102. For example, broadcast program information may be collected from any information providing servers or websites of the relevant local cable broadcast service. The collected broadcast program information may be represented in hypertext markup language (HTML) or may be EPG information encoded in a specific language.

If it is determined that it is not possible to collect the local cable broadcast channel/program information of the relevant location (for example, because of a failure to obtain location information), it is determined whether location information can be acquired in operation S103. The location information may be location information of the portable terminal having the application apparatus 10, and the location information acquiring unit 30 of the portable terminal may acquire the location information using a GPS receiver and/or based on a base station of a mobile communication network. If it is determined that it is possible to acquire the location information in operation S103, after obtaining the location information, a process proceeds to operation S102 to collect the broadcast program information based on the location information. If the location information is not acquired in operation S103, it is determined whether this acquisition failure is a temporary error in operation S104. If determined that the failure is a temporary error, a process returns to operation S103 to obtain location information, and if successful the process proceeds to operation S102. However, if the error has lasted for a specific time, acquisition of the location information is stopped, and an appropriate error message is displayed in operation S105.

In operation S106, it is determined whether the broadcast program information has been completely received within a specific time period in operation S102. The specific time period may be specified in the application apparatus 10 in consideration of the amount of broadcast program information to be received, or may be defined by the user. If it is determined that the broadcast/program information has not been completely received within the specific time period, it is determined whether this failure is caused by a temporary error in operation S104, and according to the results of this determination, the process may continue to receive the broadcast information in operation S102 or an appropriate error message is displayed in operation S105.

If it is determined that the broadcast program information has been completely received within the specific time period, the collected broadcast program information is stored in operation S107. Data may be extracted from the collected broadcast program information stored in operation S107. The extracted data may be data that may be stored in various types of databases in the information processing and storing unit 14 of the application apparatus 10 or may be data required to update the databases. Alternatively, data may be additionally extracted based on a user's selection.

In operation S108, it is determined whether the data extracted in operation 107 is redundant to the existing data, i.e., the data stored in the information processing and storing unit 14. For example, in operation S108, it is determined whether the data extracted in operation S107 has the same format as the data of the database stored in the information processing and storing unit 14, and if the data has the same format, it may be checked whether there is redundant data in the database. Alternatively, in operation S108, it may be determined whether among the data extracted in operation S107 there is the same data as in a particular database stored in the information processing and storing unit 14. If it is determined that information of the extracted data is redundant to an existing database in operation S108, the database is updated and stored in operation S109, and then the channel and relevant broadcast program information is updated in operation S110. In contrast, if it is determined in operation S108 that the extracted data is not redundant to an existing database, a new database is created, and the extracted data is stored therein in operation S111 and the channel and relevant broadcast program information is updated in operation S110.

The process shown in FIG. 3 may be applicable to a collecting process or an update process for other broadcast program information. For example, the process may be applicable to collect or update broadcast program information of a public broadcast service, IPTV broadcast service, or satellite broadcast service other than the local cable broadcast service. If the previously aggregated channel/broadcast program information has expired or a specific time has passed, broadcast program information may be collected again for the purpose of updating. Alternatively, if a location of the portable terminal having the application apparatus has changed to a different location where a local cable broadcast provider is different from that of a current location, or if the broadcast receiving device 40 to be controlled is changed, the channel/broadcast program may be collected again. The channel/broadcast program information may also be updated according to an event requested by the user.

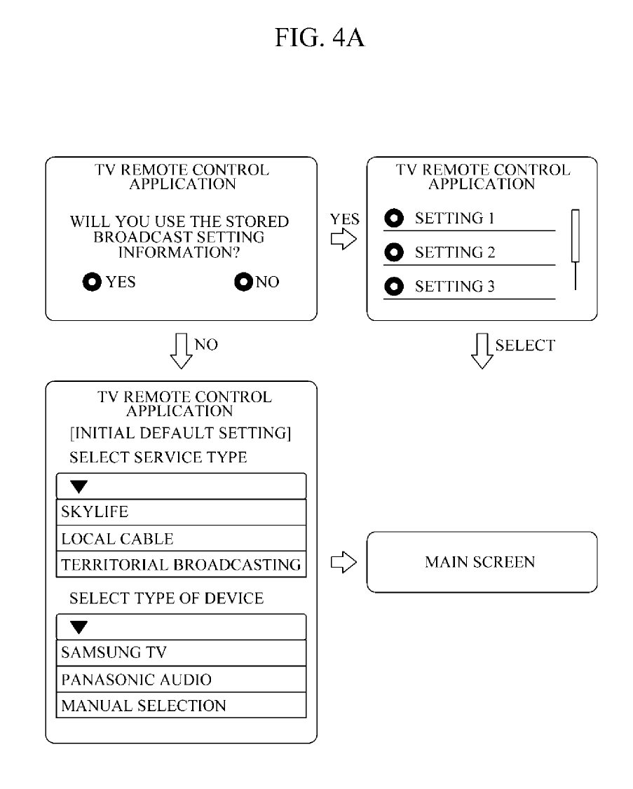

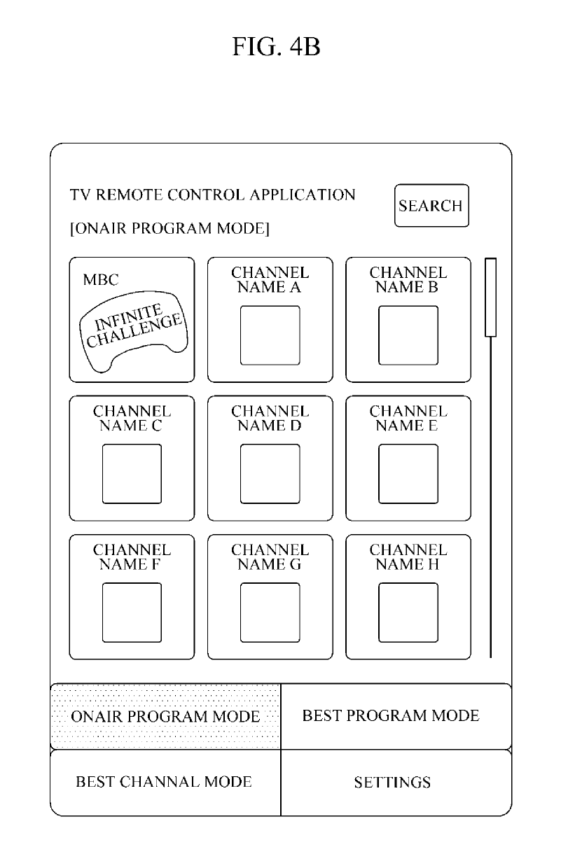

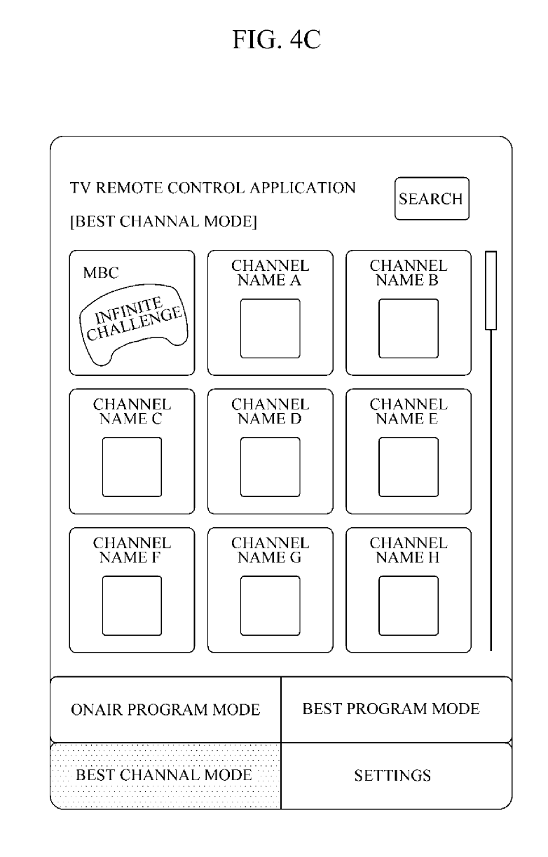

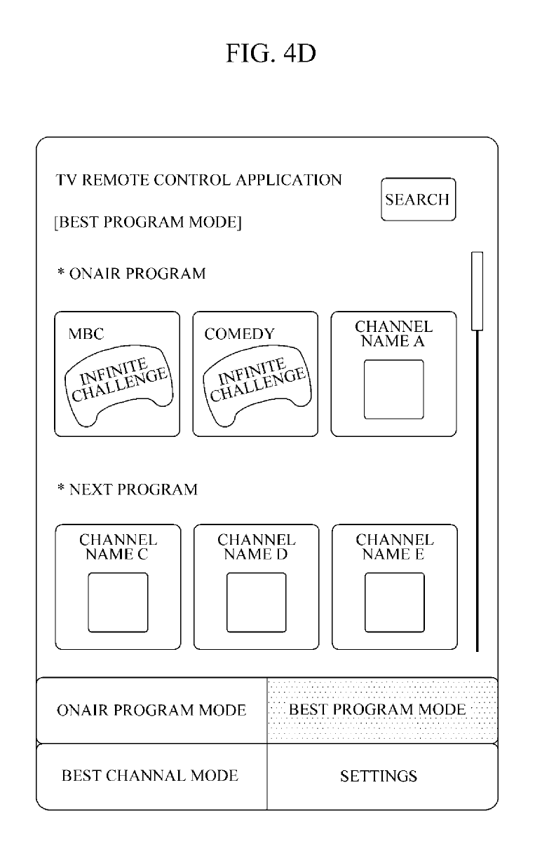

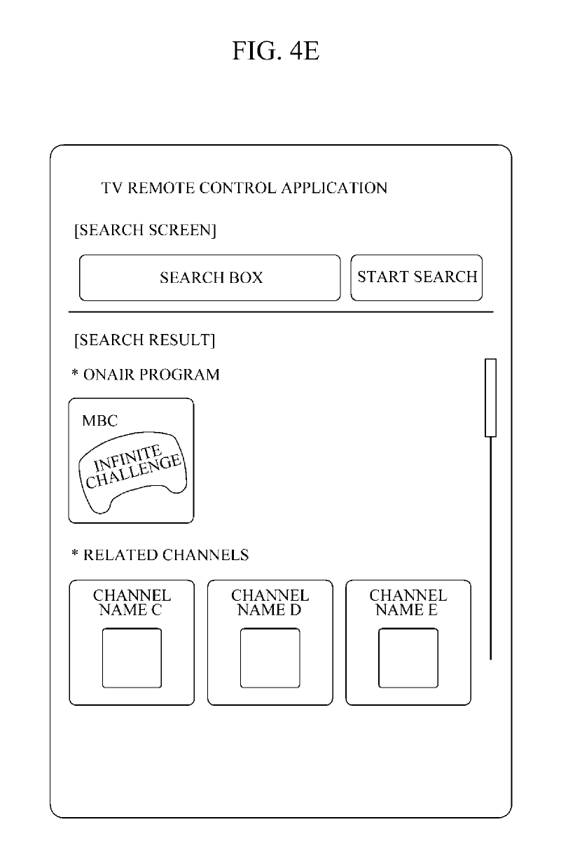

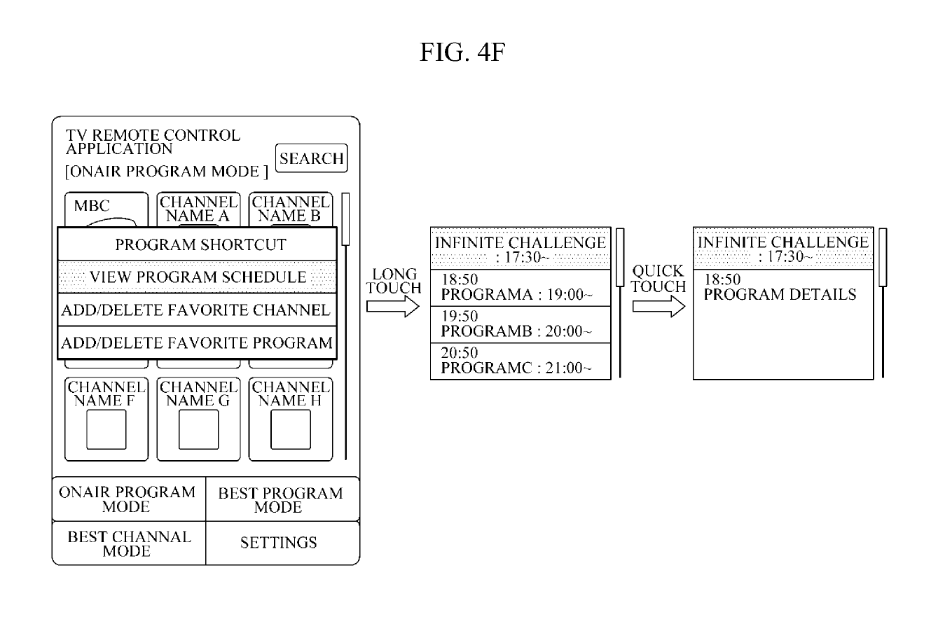

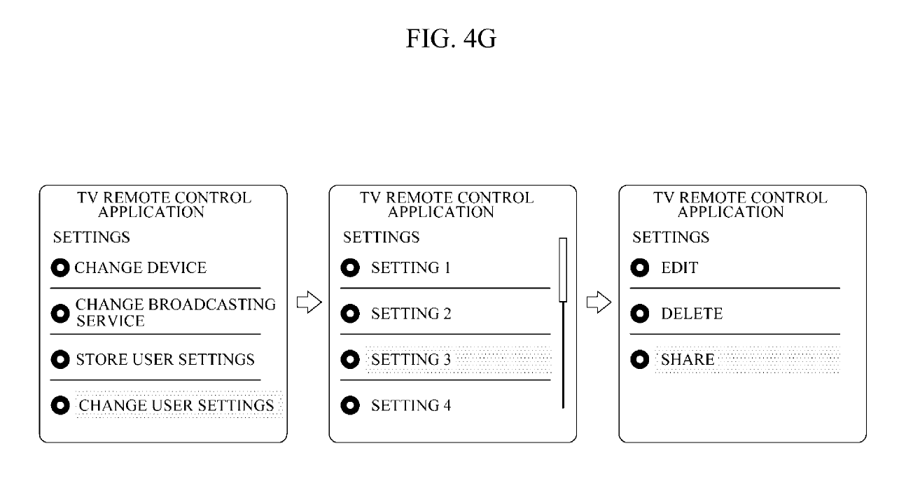

FIG. 4A, FIG. 4B, FIG. 4C, FIG. 4D, FIG. 4E, FIG. 4F, and FIG. 4G are diagrams illustrating a configuration of a UI being displayed by the UI display and processing unit of the application apparatus illustrated in FIG. 1 when operating the application apparatus 10 and procedures of processing in response to an input to the display UI. Hereinafter, UI displayed upon operating the application apparatus 10 and related operations will be described in more detail with reference to FIG. 4A, FIG. 4B, FIG. 4C, FIG. 4D, FIG. 4E, FIG. 4F, and FIG. 4G.

FIG. 4A is a diagram illustrating a user interface according to an exemplary embodiment of the invention. Referring to the upper left diagram of FIG. 4A, a user interface to select whether to use the existing broadcast setting information is displayed on a display of the portable terminal. A query regarding the selection may be generated containing various details, for example, “Will you use the stored broadcast setting information?” Upon operating of an application, the query may be shown on an initial screen in the form of a pop-up window, but the form of the query is not limited thereto. For example, the query shown in the upper left diagram of FIG. 4A may be displayed partially or entirely on the display as an operation screen. The “TV Remote Controller Application” shown on the top of each rectangular section in FIG. 2A is a name of an application apparatus or an application program which is currently operated, and is exemplary.

If the user selects “Yes” to the query shown in the top left of the diagram of FIG. 4A, i.e., if the user selects to use the stored broadcast setting information, a list is read from an existing setting database (for example, the database stored in the information processing and storing unit 14 shown in FIG. 1) and shown in the display (refer to a top right diagram of FIG. 4A). This is for the user to select one from the existing setting information (for example, Setting 1, Setting 2, and Setting 3 in FIG. 4A).

If the user selects “No” to the query shown in the top left of the diagram of FIG. 4A, i.e., if the user selects not to use the stored broadcast setting information, the display may show a screen for making new broadcast settings. For example, as shown in the bottom left of the FIG. 4A, an initial default setting screen may be displayed. In the initial default setting screen, types of services and types of broadcast receiving devices may be simultaneously or sequentially displayed for the user to choose from. The types of services show the types of broadcast services being supported in a relevant location, and may include, for example, a satellite broadcast service, a local cable broadcast service, and a territorial broadcast service, for which the user wishes to create settings. Generally, all broadcast receiving devices within the broadcast coverage area are automatically scanned to be displayed as the types of broadcast receiving devices or previously registered all types of broadcast receiving devices are displayed in a reference order (for example, in alphabetical order of producers, in order of audience share, or in order of most favorite to least favorite). In addition, if the broadcast receiving device is a new broadcast receiving device and is thus not automatically scanned or registered, a manual selection menu may be additionally displayed on an initial screen for the user to manually install the new broadcast receiving device.

A display screen, i.e., a diagram shown in the bottom left of FIG. 4A having “Select Type of Service” and “Select Type of Broadcast Device” which, respectively, include a list of types of services and a list of types of devices is only exemplary. For example, the type and order of the two menus may be changed, several menus may be displayed sequentially at the same time, or two or more or less menus may be displayed concurrently or separately. In addition, the type or the order of the list of each menu, and the number of lists being concurrently displayed may be changed.

If the user selects to use the existing broadcast setting information or the acquisition of the new broadcast setting information has been completed, information to control of the broadcast receiving device has been received, then settings for control of the broadcast receiving device (which will be described later) are created using the acquired information, and a main screen of the application apparatus 10 or the application program may be displayed. The main screen is first displayed after the initial screen as shown in FIG. 4A, and there is no limitation on the type of the screen. For example, all or some of “On Air Program Mode” (an exemplary name of a mode of displaying information of programs currently broadcast on each channel (hereinafter, referred to as “channel program information”)),” “Best Channel Mode” (an exemplary name of a mode of displaying channel program information or program information in order of a user's favorite programs), and “Best Channel Mode” (an exemplary name of a mode of displaying channel program information or channel information in order of a user's favorite channels) are displayed in a main screen. Furthermore, the mode to be first displayed in the main screen may be specified, or selected by the user.

FIG. 4B is a diagram illustrating a user interface according to an exemplary embodiment of the invention. FIG. 4B is a diagram illustrating an exemplary configuration of a main screen in “On Air Program Mode.” As described above, “On Air Program Mode” is a mode for displaying channel program information, and the name is only exemplary. In an “On Air Program Mode” screen, the information about channels and programs presently available to the user, more specifically, channel information and information about programs being currently being broadcast on each channel may be displayed as an image. For example, in “On Air Program Mode” the channel program information is displayed as icons in a specific pattern (for example, a matrix form of 3×Y (where Y is equal to or greater than 4)). Each icon may represent both the channel information and the program information. For example, the channel information may be displayed as text and the program information may be displayed as an image as shown in FIG. 4B, the channel information may be displayed as an image and the program information may be displayed as text, or both the channel information and the program information may be displayed as either images or text. Alternatively, each icon may include channel information or program information, which is displayed as either an image or text.

FIG. 4C is a diagram illustrating a user interface according to an exemplary embodiment of the invention. FIG. 4C is a diagram illustrating an exemplary configuration of a main screen in “Best Channel Mode.” As described above, “Best Channel Mode” is an exemplary name of a mode for displaying channel program information generated by combining names of channels previously registered by the user as user's favorite channels and information on programs being currently broadcast on the respective registered channels and/or information about programs to be broadcast on the respective channels. The user's favorite channels may be previously selected by the user and registered, or may be determined according to the user's viewing time, the number of times of viewing, and the like.

In a “Best Channel Mode” screen, information of channel programs currently available to the user, more specifically, channel information and information of programs being currently broadcast on each channel may be displayed as images in order based on the user's favorite channels. For example, the channel program information displayed in “Best Channel Mode” screen may be icons that are arranged in a specific pattern (for example, as shown in FIG. 4C, a matrix form of 3×Y (where Y is equal to or greater than 4)). Each icon may represent both the channel information and the program information, or represent the channel information only. The channel information may be displayed as text and the program information may be displayed as an image as shown in FIG. 4C. Further, the channel information may be displayed as an image and the program information may be displayed as text, or both the channel information and the program information may be displayed as either text or images. In a case where only the channel information or program information is displayed, the channel information or program information may be displayed as either text or an image, or the combination of text and an image.

FIG. 4D is a diagram illustrating a user interface according to an exemplary embodiment of the invention. FIG. 4D is a diagram illustrating an exemplary configuration of a main screen in “Best Program Mode.” As described above, “Best Program Mode” is an exemplary name of a mode for sequentially displaying the user's favorite programs along with channel program information including names of currently broadcast channels and/or names of channels scheduled to be broadcast. In a “Best Program Mode” screen, information on channel programs available to the user currently or in the near future, more particularly, channel information and information of programs broadcast on the respective channels may be displayed as images. For example, the channel program information displayed on the “Best Program Mode” screen may be icons that are arranged in a specific pattern (for example, a matrix of 3×Y (where Y is equal to or greater than 2) as shown in FIG. 4D). In this case, each icon may represent both the channel information and the program information, or represent the program information or channel information only. The channel information may be displayed as text and the program information may be displayed as an image as shown in FIG. 4D. Alternatively, the channel information may be displayed as an image and the program information may be displayed as text, or both the channel information and the program information may be displayed as either text or images, or as the combination of text and an image.

To display the channel program information, the channel information, or the program information, the application apparatus 10 may acquire information about programs broadcast on each channel, for example, the program title, from the database (for example, the program schedule of each channel stored in the information processing and storing unit 14 shown in FIG. 1). The application apparatus 10 may acquire images associated with the programs and/or the channels, which, are matched with the program icon database and/or the channel icon database, respectively. FIG. 4B, FIG. 4C, and FIG. 4D show examples of icons for representing the channel program information by combining the channel name and the program images. If a program does not have an image for use as an icon or there is no program currently broadcast, a channel image obtained from the channel icon database may be displayed as an icon, or an icon in any shape, for example a bar, a rectangle, a circle, or an oval, including a program title (text) along with a channel image, may be displayed.

In addition to the icons representing the channel program information, images may be displayed in the main screen or the other mode screen for the user to choose other modes supported by the application apparatus. For example, in a case where the application apparatus supports “On Air Program Mode,” “Best Program Mode,” and “Best Channel Mode,” buttons of each mode may be displayed together with or independent of the channel program information for the user to choose the desired mode. Referring to FIG. 4B, FIG. 4C, and FIG. 4D, exemplarily buttons of modes supported by the application apparatus 10 and setting buttons (i.e., buttons for a GUI for use in setting of default broadcast information, such as broadcast receiving devices and/or broadcast service providers) are displayed.

In FIG. 4B, FIG. 4C, and FIG. 4D, the mode selection screen is displayed with the channel program information at the bottom of the display, however aspects of the present invention are not limited thereto. For example, the mode selection screen may be placed on the top or edge of the display or the user may change the position of the mode selection screen as desired. In addition, the mode selection screen may be designed to be hidden and be shown in the whole or part of the display if a user's request input is received (for example, a user's touch on a mode selection screen display button).

The application apparatus 10, more specifically, the broadcast receiving device control unit 18 of FIG. 1, performs a remote control process with respect to the relevant channel and/or program in response to the user's touch on any icon on the display in “On Air Program Mode” showing the channel program information, the channel information, or the program information. The icons representing the channel program information, channel information and the program information are media to perform the remote-control process with respect to a pre-registered broadcast receiving device 40 (i.e., the broadcast receiving device 40 for which the settings are created through the initial default setting screen shown in FIG. 4A). For example, if the user touches an icon representing specific channel program information, an appropriate signal may be created and transmitted to the broadcast receiving device control unit 18. The appropriate signal may be a selection signal containing the selected channel information and program information. The broadcast receiving device control unit 18 that has received the selection signal may generate a control signal to turn the broadcast receiving device 40 to change to a relevant channel.

In an exemplary embodiment, the remote control process may be performed according to the type of mode displayed at the time of touching the channel program information and/or a type of a touch motion (for example, a quick touch or a long touch). Hereinafter, an exemplary remote control process will be described in more detail with reference to FIG. 1.

<On Air Program Mode>

As shown in FIG. 4B, the “On Air Program Mode” screen displays channel program icons, each generated by combining a name of a channel and an image of a program being currently broadcast on the relevant channel wherein the channel is found from the database stored in the information processing storing unit 14 once the broadcast services (for example, local cable broadcast) set by the user have been checked. There may be no limit on the arrangement of the channel program icons. For example, the channel program icons may be arranged in order of channel numbers or in order of the frequency of viewing and/or according to a combination of the frequency of viewing and the viewing duration.

In response to a user's quick touch on the channel program icon, the application apparatus 10 may control the broadcast receiving device 40 to immediately change its channel to a selected channel. First, the UI display and processing unit 16 may acquire information about the channel name and the program title from the selected icon. Then, the UI display and processing unit 16 may search the database stored in the information processing and storing unit 14 to find a channel number which currently broadcasts the relevant program based on the acquired information, and transmit the found channel number to the broadcast receiving device control unit 18. The broadcast receiving device control unit 18 may generate a signal using the received channel number to perform a remote control process with respect to the broadcast receiving device 40.

In response to a user's long touch on the channel program icon, the application apparatus 10 may control the display to show various sub-menus about the corresponding channel program as shown in the left-handed side of the display screen of FIG. 4F. The sub-menus may include “Program Shortcut,” “View Program Schedule,” “Add/Delete Favorite Channel,” and “Add/Delete Favorite Program.” The sub-menu may further include program details, and a part of sub-menus may be displayed. If the user chooses “Program Shortcut” from the sub-menus, the same process may be executed as performed when a quick touch occurs on the channel program icon. Furthermore, if “View Program Schedule” or “View Program Details” is chosen, the UI display and processing unit 16 may search for the selected information and display the found information on the display.

“Add/Delete Favorite Channel” and “Add/Delete Favorite Program” may be displayed differently depending on whether a relevant channel or program has been already added as favorite. For example, for a previously added channel or program, the sub-menu may be “Delete Favorite Channel (or Program)” whereas for a new channel or program that has not been yet added as favorite, the sub-menu may be “Add Favorite Channel (or Program).” Moreover, if a user chooses a menu of “Add Favorite Channel (or Program),” a channel or program represented by the channel program icon may be included in a list of user's favorite channels or user's favorite programs, and when the user chooses a menu of “Delete Favorite Channel (or Program),” a channel or program indicated by the channel program icon may be removed from a list of use's favorite channels or user's favorite programs.

FIG. 4F is a diagram illustrating a user interface according to an exemplary embodiment of the invention. As shown in FIG. 4F, if the user selects “View Program Schedule” from the sub-menus, a schedule of broadcast programs on a channel represented by the icon that has been selected by the user may be displayed. The broadcast program schedule may be a table including program titles and broadcasting times of the relevant programs. A quick touch or a long touch on a specific program on the program schedule may initiate different operations. More specifically, the quick touch on a specific broadcast program of the program schedule may enable displaying of information about details of the relevant program (refer to FIG. 4F). In comparison, the long touch on a specific broadcast program may allow showing another sub-menu that enumerates “Record,” “Reservation-Record,” “Notify,” and “Add/Delete Favorite Program.” For a currently broadcast program, the “Record” menu may be displayed, and for a program scheduled to be broadcast, the “Reservation-Record” menu may be displayed. The “Notify” menu may generate a notification signal to notify the user of the beginning of a program, which may be deactivated if a selected program is currently broadcast. Further, the “Add/Delete Favorite Program” menu may be substantially the same as “Add/Delete Favorite Program” described above.

If the user touches a menu key or a menu button, other operations to perform the remote control process with respect to the broadcast receiving device may be carried out. The menu key may be a button-type key provided to the portable terminal having the application apparatus 10, and the menu button may be an input button displayed on the display. An operation for the user to choose a method of displaying icons of currently broadcast programs may be executed in response to the user's touch on a menu key or a menu button More specifically, in “On Air Program Mode,” clicking a menu key enables the user to select a method of arranging channel program icons on the display. For example, sub-menus may be displayed for the user to choose from a method of simultaneously displaying all channel program icons and a method of displaying channel program icons according to the genre, e.g., News/Information, Drama/Movie, Show/Music, Celebrity/Entertainment, and the like. An additional sub-menu may be provided for the user to choose an arrangement order for multiple icons, such as, order of preference, order of channels, alphabetical order of program titles, and historical order. The channel program icons may be arranged according to the display method selected by the user. For example, the display may be configured for the user to be able to to access currently broadcast programs by genre, such as Drama/Movie and Celebrity/Entertainment.

Referring to FIG. 4B and FIG. 4D, a search box may appear upon touching a search button. FIG. 4E is a diagram illustrating a user interface according to an exemplary embodiment of the invention. As shown in FIG. 4E, along with the search box, a search start button and/or a search result displaying area may be displayed. If the user inputs a program title, a channel name, or a related search word (for example, a main character's name or genre of the program) in the search box, a program currently broadcast or scheduled to be broadcast can be found along with the search target channel. The search result may be displayed as an icon together with the channel program icons in an area, such as On Air Program icon area and a related channel icon area. The icon may be a channel program icon produced by combining a channel name related to the search word and an image of a program currently broadcast or scheduled to be broadcast, but aspects of the present invention are not limited thereto. A quick touch or a long touch on a specific icon in the search result may enable an operation to be executed according to a specific algorithm, and may lead to, for example, the same remote control process as performed when the quick or long touch on the channel program icon occurs in the “On Air Program Mode” screen described above to be executed.

<Best Channel Mode>

As shown in FIG. 4C, the “Best Channel Mode” screen displays channel program icons with respect to a program selected by the user or determined by a specific criteria (e.g., viewing duration and/or the frequency of viewing) wherein each of the channel program icons is generated by combining the program and an icon of each channel on which the program is currently broadcast or on which the program is scheduled to be broadcast. The channel program icons may be arranged in order of preference, in order of channel numbers with respect to the program having a certain level of preference, or in order of channels that are currently broadcasting the program.

In response to a user's quick touch on a channel program icon, the application apparatus 10 may control the broadcast receiving device 40 to immediately change its channel to a selected channel. In response to a user's long touch on the channel program icon, the application apparatus 10 may control various sub-menus to appear on the display with respect to the channel program. The sub-menus may include “Program Shortcut,” “View Program Schedule,” “Add/Delete Favorite Channel,” and “Add/Delete Favorite Program.” The sub-menu may further include program details, and a part of sub-menus may be displayed. If the user chooses “Program Shortcut” from the sub-menus, the same process may be executed as performed when a quick touch occurs on the channel program icon. Moreover, if the user selects “View Program Schedule” or “View Program Details,” the UI display and processing unit 16 may search for relevant information and display the found information on the display. In response to selecting “Delete Favorite Channel,” the selected channel may be removed from a list of user's favorite channels.

“Add/Delete Favorite Program” may be displayed differently depending on whether or not a currently broadcast program has been already added as favorite. For example, for a previously added program, the sub-menu shows “Delete Favorite Program” whereas for a new program that has not been yet added as favorite, the sub-menu may be “Add Favorite Program.” Moreover, if the user chooses a menu of “Add Favorite Program,” a program represented by the selected channel program icon may be included in a list of user's favorite programs, and if a user chooses a menu of “Delete Favorite Program,” a channel indicated by the selected channel program icon may be removed from the list of user's favorite programs.

If the user selects “View Program Schedule” from the sub-menus, a schedule of broadcast programs on a channel represented by an icon that has been selected by the user may be displayed. The broadcast program schedule may be a table including program titles and broadcast times. A quick touch or a long touch on a specific program on the program schedule may initiate different operations. More specifically, the quick touch on a specific broadcast program of the program schedule may enable displaying information about details of the program. In comparison, the long touch on a specific broadcast program may allow showing another sub-menu that enumerates “Record,” “Reservation-Record,” “Notify,” and “Add/Delete Favorite Program.” For a currently broadcast program, the “Record” menu may be displayed, and for a program scheduled to be broadcast, the “Reservation-Record” menu may be displayed. The “Notify” menu may generate a notification signal to notify the user of the beginning of a program, which may be deactivated if a selected program is currently broadcast. Further, the “Add/Delete Favorite Program” menu may be substantially the same as “Add/Delete Favorite Program” described above.

If the user touches a menu key or a menu button, other operations to perform the remote control process with respect to the broadcast receiving device may be carried out. The menu key may be a button-type key provided to the portable terminal having the application apparatus 10, and the menu button may be an input button displayed on the display.

An operation for a user to choose a method of displaying icons of favorite channels may be executed in response to the user's touch on a menu key or a menu button. More specifically, clicking on a menu key in “Best Channel Mode” screen enables the user to select a method of arranging channel program icons or channel icons on the display. For example, sub-menus may be displayed for the user to choose from a method of simultaneously displaying all channel program icons and a method of displaying channel program icons by genre, such as, News/Information, Drama/Movie, Show/Music, Celebrity/Entertainment, and the like. An additional sub-menu may be provided for the user to choose an arrangement order for multiple icons, such as, order of preference, order of channels, alphabetical order of program titles, and historical order. The channel program icons may be arranged according to the display method selected by the user. For example, the display may be configured for the user to be able to access currently broadcast programs by genre, such as Drama/Movie and Celebrity/Entertainment.

<Best Program Mode>

As shown in FIG. 4D, “Best Program Mode” screen displays channel program icons or program icons in connection with the user's favorite programs which results from confirming the broadcast service set by the user and searching the database stored in the information processing and storing unit 14. There is no limit on the arrangement order of the channel program icons or program icons for the user's favorite programs. For example, the channel program icons may be arranged in alphabetical order of program titles, in order of the frequency of viewing and/or in order of the combination of the frequency of viewing and the viewing duration of each program. Alternatively, as shown in FIG. 4D, the display may be divided into areas, one area for displaying channels currently broadcasting a relevant program and the other for displaying channels scheduled to broadcast the program, and the channel program icons may be arranged in each area.

In response to a user's quick touch on an icon of a channel on which the user's specific favorite program is currently broadcast, the application apparatus 10 may control the broadcast receiving device 40 to immediately change its channel to a selected channel. In response to a user's long touch on an icon of a channel on which the specific favorite program is currently broadcast, the application apparatus 10 may control various sub-menus to appear on the display with respect to the channel and the program. The sub-menus may include “Program Shortcut,” “View Program Details,” “Record,” “Add/Delete Favorite Channel,” and “Add/Delete Favorite Program.” If the user chooses “Program Shortcut” from the sub-menus, the same process may be executed as performed when a quick touch occurs on the channel program icon. Moreover, if the user selects “View Program Details,” the UI display and processing unit 16 may search for relevant information and display the found information on the display. In response to selecting “Add/Delete Favorite Program,” the selected program may be removed from a list of user's favorite programs.

“Add/Delete Favorite Channel” may be displayed differently depending on whether or not a channel which is broadcasting the selected program has been already added as favorite. For example, for a previously added channel, the sub-menu shows “Delete Favorite Channel” whereas for a new channel that has not been yet added as favorite, the sub-menu shows “Add Favorite Channel.” Moreover, if the user chooses a menu of “Add Favorite Channel,” a channel represented by the selected channel program icon may be included in a list of user's favorite channels, and when the user chooses a menu of “Delete Favorite Channel,” a channel indicated by the selected channel program icon may be removed from the list of user's favorite channels.

The application apparatus 10 may control various sub-menus in relation to the program to appear on the display in response to a quick touch or a long touch on a channel that is scheduled to broadcast a specific favorite program. The sub-menus may include “View Program Details,” “Reservation-Record,” “Add/Delete Favorite Channel,” and “Delete Favorite Program.” The “Add/Delete Favorite Channel” may add a selected channel as favorite if the selected channel has not yet been in user's favorite channels, and may delete a selected channel if the selected channel has already been in user's favorite channels. “Delete Favorite Program” may delete the selected program from a list of user's favorite programs.

Hereinafter, an operation and a screen configuration which result from touching a setting button on the display screen shown in the examples illustrated in FIG. 4B, FIG. 4C, and FIG. 4D will be described. As described above, a setting button is provided to proceed to a GUI for setting default broadcast information, such as broadcast receiving devices and/or broadcast service providers.

FIG. 4G is a diagram illustrating a user interface according to an exemplary embodiment of the invention. In response to a touch on a setting button on the display screen shown in FIG. 4B, FIG. 4C, and FIG. 4D, the display may show various setting menu lists. For example, referring to FIG. 4G, the display may show four setting menu lists including “Change Device,” “Change Broadcasting Service,” “Store User Settings,” and “Change User Settings”. The menu of “Change Device” may allow a user to change the broadcast receiving device from a list of the broadcast receiving devices available, and the menu of “Change Broadcasting Service” may allow a user to change the type of broadcast service from a list of the broadcast services available (refer to the bottom left of FIG. 4A). The menu of “Store User Settings” may allow the user to store the currently set broadcast setting information, i.e., the type of the broadcast receiving device and the type of the broadcast service being used, and thus the user may be able to use the stored settings when executing a remote control process.

FIG. 4G is a diagram illustrating an example of the screen displayed when the user chooses a menu of “Change User Settings.” Referring to FIG. 4G, in response to the user's selection of the “Change User Settings” menu, a list of previously stored broadcast setting information may be displayed. In response to a quick touch on specific settings in the displayed setting list, a query that asks whether to change the broadcast settings to the selected settings may appear in the form of pop-up window. If the answer is positive, the broadcast setting information is changed in accordance with the selected settings. In response to a long touch on specific settings in the setting list, a sub-menu including “Edit,” “Delete,” and “Share” may appear to edit, delete, or share information of the selected settings. To “Share” is to transmit the information through an information sharing medium, such as transfer via a communication operation which is supported by the portable terminal having the application apparatus 10. The information sharing medium may include, for example, data communication, emails, messaging, transfer via Bluetooth®, transfer via social network services (SNS), and the like.

Hereinafter, an example of procedures for controlling the broadcast receiving device 40 by the broadcast receiving device control unit 18 (hereinafter, it will be referred to simply as a “control unit”) will be described. The control unit 18 may first create settings to make the broadcast receiving device 40 controllable, and then may execute the application apparatus 10 to manipulate the broadcast receiving device 40.

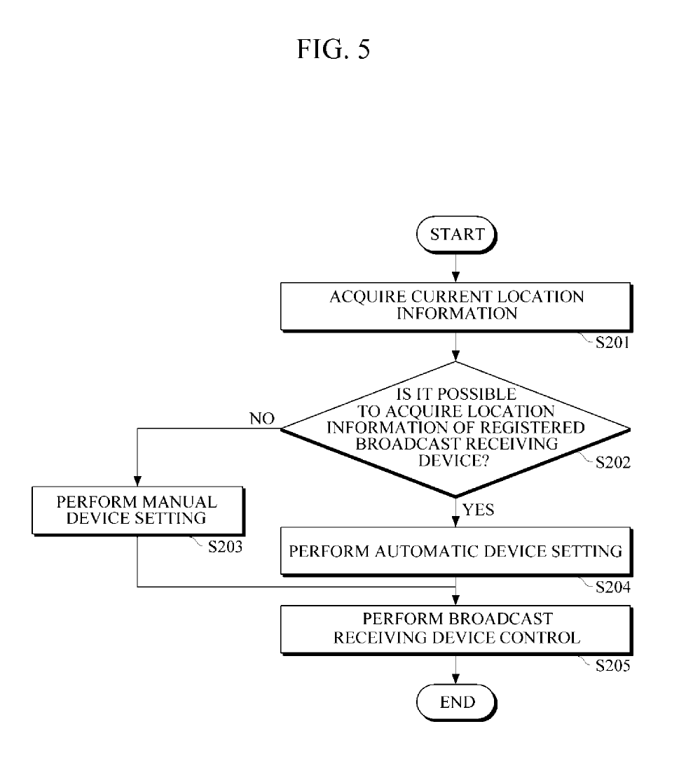

FIG. 5 is a flowchart illustrating a method for controlling a broadcast receiving device according to an exemplary embodiment of the present invention. The flowchart illustrated in FIG. 5 may show procedures performed in response to a user selecting a specific channel program icon, a specific program icon, or a specific channel icon in one mode screen which is displayed from among mode screens of “On Air Program Mode,” “Best Channel Mode,” and “Best Program Mode.” For example, the flowchart of FIG. 5 may be performed at an arbitrary time that is selected by the user, or the first time that setting of a broadcast receiving device is required (for example, in response to a user's selection of a specific program icon, information about the selected program is transmitted from a control unit of the broadcast receiving device).

Referring to FIG. 1 and FIG. 5, the control unit 18 acquires current location information of the portable terminal having the application apparatus 10 in operation S201. As described above, the location information of the portable terminal may be acquired by the location information acquiring unit 30 of the portable terminal, and the acquired information may be transmitted to the control unit 18 via the information collecting unit 12. In operation S202, the control unit 18 determines whether a broadcast receiving device 40 that has been registered in the information processing and storing unit 14 is present at a location indicated by the location information, and whether information about the registered broadcast receiving device 40 can be obtained at the indicated location. The information about the registered broadcast receiving device 40 may be stored in the information processing and storing unit 14. If it is determined in operation S202 that there is no broadcast receiving device registered at the indicated location, the process proceeds to operation S203 to perform manual device setting. In contrast, if it is determined in operation S202 that there is a broadcast receiving device registered at the indicated location, the process proceeds to operation S204 to perform automatic device setting. Once the settings for the broadcast receiving device has been completed in operation S203 or operation S204, the broadcast receiving device 40 is controlled to reproduce a selected program on an arbitrary channel or a selected program on a selected channel in operation S205.

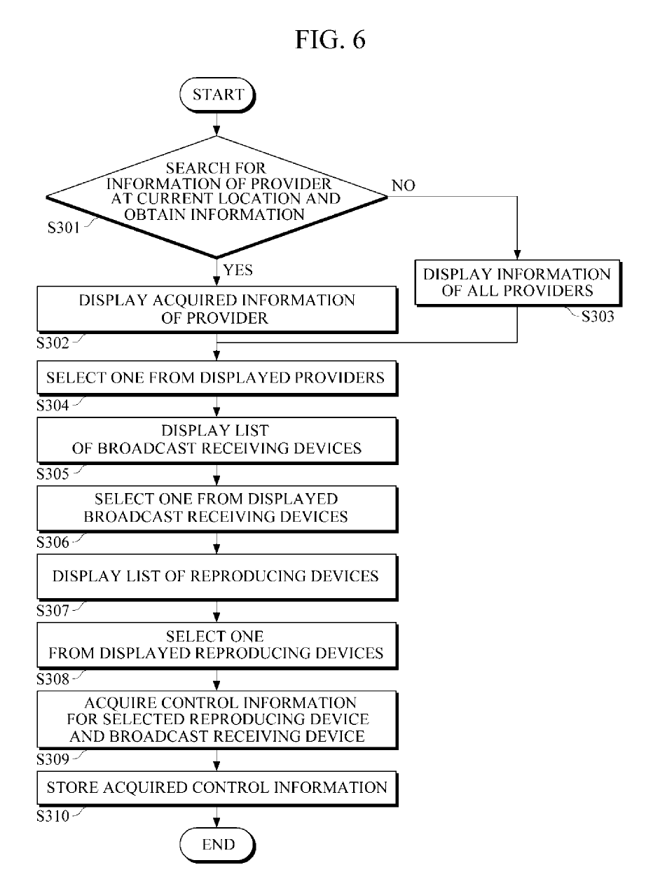

FIG. 6 is a flowchart illustrating a method for manually settings the broadcast receiving device of FIG. 5 according to an exemplary embodiment of the present invention. The manual device setting occurs in operation S203 of FIG. 5. The procedures shown in FIG. 6 are performed if there is no registered broadcast receiving device at the current location.

Referring to FIG. 1 and FIG. 6, information of service providers that are present at the current location is found and obtained in operation S301. The information of service providers may be collected by the information collecting unit 12 based on the current location information. The information collecting unit 12 may collect information of broadcast receiving devices that are placed at the current location using the current location information, and the collected information of service providers and/or of broadcast receiving devices may be stored in the information processing and storing unit 14.

In operation S302, only service providers at the present location may be shown on the display of the portable terminal. If application apparatus 10 fails to acquire the information of service providers at the present location in operation S301, the display of the portable terminal may display a list of all service providers in operation S303. The user may choose an appropriate service provider from the display list of service providers. Here, the service providers refer to entities that provide broadcast programs, and may include, for example, IPTV providers, satellite broadcast service providers, local cable broadcast service providers, territorial broadcast service providers, and the like.

In response to displaying the service providers in operation S302 or S303, the user selects one service provider from the displayed service providers in operation S304. If the selected service provider provides multiple broadcast receiving devices (for example, various types of set-top boxes), a list of the relevant broadcast receiving devices is displayed in operation S305. In operation S306, the user selects an appropriate broadcast receiving device from the displayed list. If the selected service provider provides only one type of broadcast receiving device, the aforementioned operation S305 and operation S306 may be omitted.

In operation S307, a list of reproducing devices for reproducing a selected broadcast program is displayed. The list of reproducing devices may include televisions, monitors, audio players, and any devices that can reproduce the content. In operation S307, a list of only reproducing devices that can reproduce a desired broadcast program (content) may be displayed in consideration of a type of the desired broadcast program. In operation S308, the user chooses one reproducing device from the displayed list of reproducing devices.

In operation S309, control information for the selected broadcast receiving device and the selected reproducing device is acquired. The control information refers to unique device control information for remote control of the broadcast receiving device or the reproducing device. For example, the control information may be for transmitting a control signal via a network, such as a personal area network including an infrared data communication network, such as IrDA, a wireless LAN (WiFi), a wire LAN, and Bluetooth®. The control information acquired in operation S309 is stored in the information processing and storing unit 14 in operation S310 for future use by the user without repeating the manual device setting.

As an example of the manual device setting, under the assumption that the user has XX IPTV, YY TV supporting digital living network alliance (DLNA), an audio player supporting a personal area network, such as Bluetooth®, a home theater being connected to a home network, and network attached storage (NAS) supporting DLNA, when the user wishes to view movie A, a terminal may proceed to connect to a DLNA device using a network device search, search for the movie A and search for a TV supporting DLNA, and reproduce the movie on the found TV. If it fails to search for the movie A in the DLNA device, the user is guided to choose a service provider (XX IPTV or YY TV) that is currently broadcasting the movie A or is scheduled to broadcast the movie A from among broadcast service providers that provide broadcast services at the current location, and when the user chooses the service provider as guided, the user is further guided to choose a reproducing device. In the case of selecting YY TV, based on information of the YY TV, a present channel of the YY TV is immediately changed to a channel that is broadcasting the movie A, or scheduled viewing of the movie A is set when the movie A is scheduled to be broadcast.

In another example, in the presence of the NAS supporting DLNA and a TV accessible to the NAS, the TV is controlled to reproduce the content present in the NAS.

In another example, a playlist of songs that can be reproduced by the audio player or the home theater is obtained from the NAS, and the songs that the user wants from the playlist may be automatically reproduced, or if there are no desired songs in the playlist, the corresponding songs may be found and reproduced.

In another example, the control of a territorial DMB receiver may be further supported, so that the content can be consistently reproduced while in motion.

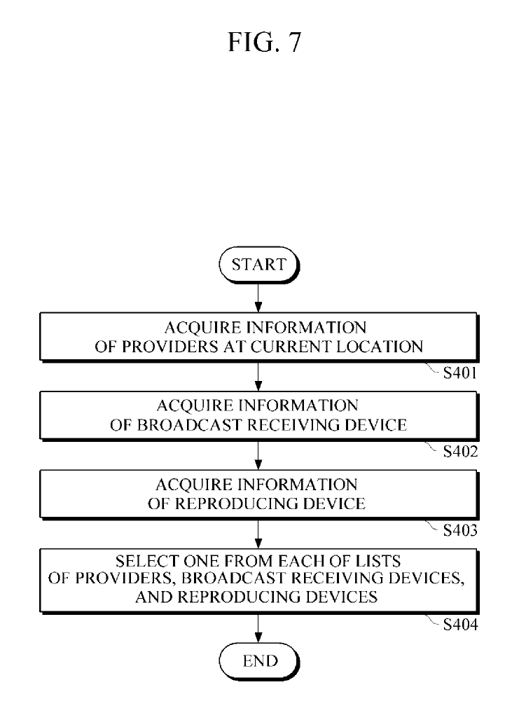

FIG. 7 is a flowchart illustrating a method for automatically programming a broadcast receiving device in FIG. 5 according to an exemplary embodiment of the present invention. FIG. 7 is a flowchart illustrating procedures for automatically programming settings for a broadcast receiving device in operation S204 of FIG. 5. As described above, the automatic device setting procedures may be performed if information about the broadcast receiving device registered at the current location is present. The automatic device setting procedures may enable the user to control the broadcast receiving device to reproduce a desired content or broadcast program with minimum manipulation based on the device information that has been set or disclosed, even if the device moves from the current location.

Referring to FIG. 1 and FIG. 7, information of service providers at the current location is acquired from the information processing and storing unit 14 in operation S401. Information of broadcast receiving devices of each service provider is found and acquired in operation S402, and information of reproducing devices associated with each broadcast receiving device is found and acquired in operation S403. The information of broadcast receiving device and of reproducing device may be stored in the information processing storing unit 14. If multiple service providers, broadcast receiving devices, and reproducing devices are found in operation S401, operation S402, and operation S403, the user may choose one from each of the service providers, the broadcast receiving devices, and the reproducing devices in operation S404. In contrast, operation S404 can be omitted if there is only one service provider found in operation S401, only one broadcast receiving device in operation S402, and only one reproducing device in operation S403.

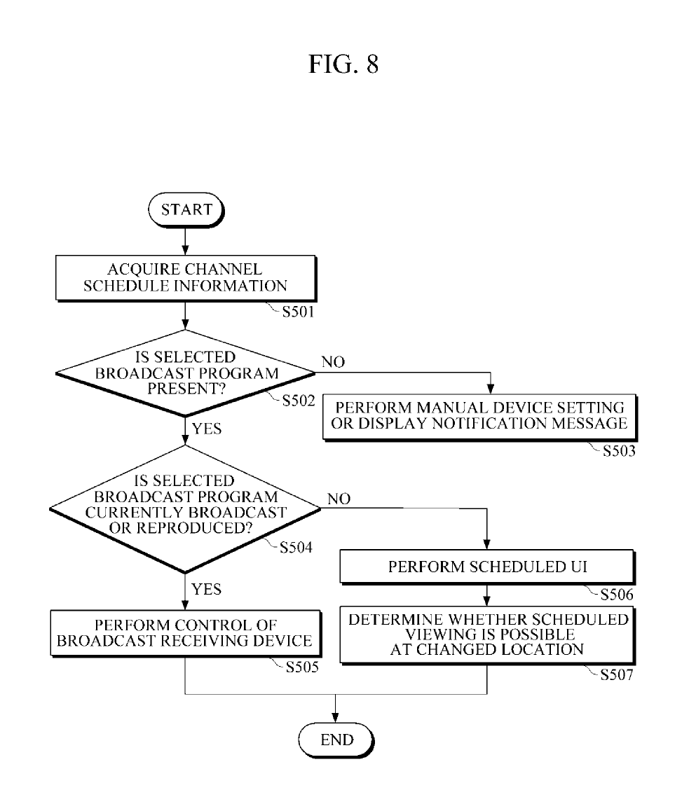

FIG. 8 is a flowchart illustrating a method for controlling a broadcast receiving device in FIG. 5 according to an exemplary embodiment of the present invention. FIG. 8 is a flowchart illustrating procedures for controlling a device in operation S205 shown in the flowchart of FIG. 5. As described above, the procedures shown in FIG. 8 may be performed after manually programming the settings in operation S203 or after automatically programming the settings in operation S204.

Referring to FIG. 1 and FIG. 8, after the settings for the device has been programmed in operation S203 or operation S204 and the control information of the device has been acquired, channel schedule information of programs to currently broadcast or scheduled to be broadcast by the broadcast receiving device based on the acquired control information is obtained in operation S501. The channel schedule information may be obtained by searching the database stored in the information processing and storing unit 14. The acquired channel schedule information is searched to determine whether content or a broadcast program selected by the user exists in operation S502. If there is no corresponding content or broadcast program, the process automatically proceeds to the procedures for manually programming the settings for the device as shown in FIG. 6, such that the device setting procedures can be performed again, or a notification message is displayed to inform the user that no corresponding content or broadcast program is present in operation S503.

If the corresponding content or broadcast program is found in operation S502, further searching is performed to determine whether or not the corresponding content or broadcast program is currently broadcast or reproduced in operation S504. If the corresponding content or broadcast program is currently broadcast or reproduced, the control of the broadcast receiving device 40 is carried out in operation S505. Accordingly, the broadcast receiving device 40 may be controlled with respect to the reproduction of the content or the channel which is broadcasting the broadcast program.

If it is determined in operation S504 that the corresponding content or broadcast program has not been yet reproduced or broadcast, a scheduled viewing UI is executed in operation S506, such that the user can view the broadcast program at the airtime. In scheduled viewing, if the portable device having the application apparatus 10 has been moved to another location at the scheduled time, it is determined in operation S507 whether or not it is possible to view the broadcast program at the scheduled time by performing the device setting procedures of FIG. 6 or FIG. 7 with respect to the location where the portable device will be placed. Thus, even if the user moves to a different location, the user may be able to view a broadcast program with manipulation.

According to the exemplary embodiments, a user may control a variety of types of broadcast receiving devices using a terminal, such as a mobile communication terminal, that is carried with the user to view a broadcast program. Even if the location of the user, or a broadcast service provider, or a type of the broadcast receiving device is changed, the user can view a broadcast program using the same graphic interface (for example, a channel program icon, a channel icon, a program icon, and the like). The application apparatus according to the exemplary embodiments of the present invention may provide a user's favorite program according to the user's personal taste or may provide broadcast program information according to genre.

In addition to the aforementioned disclosure of the application apparatus, additional functions may be possible. For example, if the user selects broadcast program A, various information, such as information for multiple channels, each of which currently broadcasts the program A or is scheduled to broadcast the program A, and information about the airtime of the broadcast program A on each channel, may be simultaneously displayed. Furthermore, a list of user's favorite broadcast programs may be separately stored, and the scheduled viewing of each favorite broadcast program may be allowed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus of a portable terminal to manipulate a first broadcast receiving device, comprising:
an information collecting unit to collect broadcast program information for a broadcast service provider;
a user interface and processing unit to generate a user interface based on the collected broadcast program information, and to receive a user input through the user interface; and
a broadcast receiving device control unit to generate a signal to manipulate the first broadcast receiving device in response to the user input.

2. The apparatus of claim 1, further comprising:
a location information acquiring unit to acquire a location of the portable terminal,
wherein the collected broadcast program information is for the location of the portable terminal.

3. The apparatus of claim 2, wherein the location is obtained from a GPS receiver or a base station of a mobile communication network.

4. The apparatus of claim 1, wherein the broadcast service provider is at least one of a local cable broadcasting service, a satellite broadcast service, a terrestrial digital multimedia broadcast (DMB) service, a local cable broadcast service, and an internet protocol television (IPTV) service.

5. The apparatus of claim 1, wherein the information collecting unit collects control information for the first broadcast receiving device.

6. The apparatus of claim 1, wherein the user interface is displayed on a display of the portable terminal.

7. The apparatus of claim 1, wherein the first broadcast receiving device is at least one of a television receiver, a television, a personal computer, a table computer, a portable multimedia player, a mobile communication terminal, a smart phone, and a navigation device.

8. The apparatus of claim 1, wherein the broadcast program information comprises channel information and program information.

9. An apparatus of a portable terminal to manipulate a first receiving device and a second receiving device, comprising:
a location information acquiring unit to acquire a first location of the portable terminal and the first receiving device;
an information collecting unit to collect first broadcast program information for a first broadcast service provider based on the location of the first receiving device;
a user interface and processing unit to generate a first user interface based on the first broadcast program information, and to receive a user input through the user interface; and
a broadcast receiving device control unit to generate a signal to manipulate the first broadcast receiving device,
wherein in response to a change of the portable terminal from the first location to a second location:
the information collecting unit collects second broadcast program information for a second broadcast service provider based on the second location,
the user interface and processing unit generates a second user interface based on the second broadcast program information, and
the broadcast receiving device control unit generates a signal to manipulate the second broadcast receiving device in the second location.

10. The apparatus of claim 9, wherein the first location and second location are obtained from a GPS receiver or a base station of a mobile communication network.

11. The apparatus of claim 9, wherein the broadcast service provider is at least one of a local cable broadcasting service, a satellite broadcast service, a terrestrial digital multimedia broadcast (DMB) service, a local cable broadcast service, and an internet protocol television (IPTV) service.

12. The apparatus of claim 9, wherein the information collecting unit collects control information for the first broadcast receiving device and the second broadcast receiving device.

13. The apparatus of claim 9, wherein the user interface is displayed on a display of the portable terminal.

14. The apparatus of claim 9, wherein the first broadcast receiving device and the second broadcast receiving device are each at least one of a television receiver, a television, a personal computer, a table computer, a portable multimedia player, a mobile communication terminal, a smart phone, and a navigation device.

15. The apparatus of claim 9, wherein the first broadcast program information and the second broadcast program information comprise channel information and program information.

16. A method for manipulating a broadcast receiving device, comprising:
obtaining first location information of a portable device;
obtaining a first broadcast program information of a first broadcast service provider according to the first location information;
generating a first user interface according to the first broadcast program information; and
in response to a first request, generating a signal to control a first broadcast receiving device located in the first location.

17. The method of claim 16, further comprising, in response to a change in location of the portable terminal:
obtaining a second location information for the portable device;
obtaining a second broadcast program information of a second broadcast service provider according to the second location information;
generating a second user interface according to the second broadcast program information; and
in response to a second request, generating a signal to control a second broadcast receiving device located in the second location.

18. The method of claim 17, wherein the first broadcast service provider and the second broadcast service provider are each at least one of a local cable broadcasting service, a satellite broadcast service, a terrestrial digital multimedia broadcast (DMB) service, a local cable broadcast service, and an internet protocol television (IPTV) service.

19. The method of claim 17, wherein the first broadcast receiving device and the second broadcast receiving device are each at least one of a cable converter box, a television, a personal computer, a table computer, a portable multimedia player, a mobile communication terminal, a smart phone, and a navigation device.

20. The method of claim 17, wherein the first location information and the second location information are obtained from a GPS receiver or a base station of a mobile communication network.

21. A broadcast receiving device to be manipulated by a portable communication terminal, comprising:
a communication unit to transmit broadcast program information of a broadcast service provider to the portable terminal and to receive a user input from the portable terminal;
a manipulation unit to perform an operation in response to an input from the portable terminal,
wherein the broadcast service provider is at least one of a local cable broadcasting service, a satellite broadcast service, a terrestrial digital multimedia broadcast (DMB) service, a local cable broadcast service, and an internet protocol television (IPTV) service.
